(19) United States
(12) Patent Application Publication
(10) Pub. No.: US 2004/0065593 A1
(43) Pub. Date: Apr. 8, 2004

(54) Automated magnetic sorter

(75) Inventor: Rung Fu Duo, Fulton, MD (US)

Correspondence Address: Max Stul Oppenheimer, P.O. Box 50, Stevenson, MD, 21153, US

(73) Assignee: CELL WORKS INC. (A Delaware Corporation)

(21) Appl. No.: 10/673,011

(22) Filed: Sep. 26, 2003

Related U.S. Application Data
(60) Provisional application No. 60/413,987, filed on Sep. 26, 2002.

(51) Int. Cl. B03C 1/00

(52) U.S. Cl. 209/215; 209/214

(57) ABSTRACT

A device for concentrating cells of interest from a fluid sample comprises an array of electromagnets associated with an array of holders for containers of the fluid samples, said electromagnets controlled by a microprocessor to generate controllable magnetic fields. Magnetic beads having an affinity for certain of the cells in the fluid sample are added to the fluid sample. When the microprocessor applies electrical current to the electrical magnet(s), the cells linked with magnetic beads will be attracted to the tube wall. Liquid aspirated from the sample will contain comparatively few of the cells for which the magnetic beads have an affinity, thereby allowing concentration of cells of interest. Optionally, aspiration may be accomplished using a robotic pipette system.

### NON-PROVISIONAL PATENT APPLICATION

This application is entitled to, and claims the benefit of, priority from U.S. Provisional Application Serial No. 60,413,987, filed Sep. 26, 2002.

### FIELD AND BACKGROUND OF THE INVENTION

1. Field of the Invention

The invention described herein relates in general to separation of components from bodily fluids, and more specifically to separation by magnetic means.

2. Background Information

Many diagnostic techniques require the separation of specific types of cells from a bodily fluid.

For example, the Circulating Cancer Cell Test (CCCT) developed by Cell Works Inc. isolates cancer cells to a slide from 10-20 ml of patient blood. After staining, a total number of cancer cells on the slide can be counted and the cancer cell images can be taken. This information assists a physician in analyzing the effectiveness of the treatment of a cancer patient.

A sample of patient blood contains many components, only a small fraction of which are of interest in analyzing for cancer cells. It is therefore a challenge to increase the fraction of cells of interest so as to make identification and counting easier.

One prior art approach has been to attempt to select compounds with a preferential affinity for the cells of interest, thereby enabling concentration of such cells prior to detection and counting. Simple statistics then permit calculating the fraction of such cells in the blood. Unfortunately, this requires a priori knowledge of the cells of interest, and works only when it is possible to identify a compound with preferential affinity for the cells of interest and not for other components of the patient blood.

The approach of the CCCT is to utilize compounds with selective affinity for the blood components which are NOT of interest, and to separate those out prior to detection, thereby concentrating the cells of interest but not requiring any a priori knowledge as to those cells. One technique for doing so is to attach magnetic beads to certain blood components (for example, leukocytes), then place the sample in a strong magnetic field so as to fix the bead-blood conjugate, thereby allowing separation of the remaining sample components. Prior art techniques utilize a permanent magnet to separate the bound cells. Please refer to FIG. 6 for a traditional Magnetic Sorter (Z). A Permanent Magnet (ZA) is mounted in the center of the sorter. Two rows of Tube Slots (ZB) are provided in both side of the Permanent Magnet (ZA). A test tube (ZC) containing a mixture of cells is placed in proximity to a Permanent Magnet (ZA). The Magnet (ZA) draws the bound cells (ZD). While this is intended to leave the unbound cells free to be removed by pipette, in practice many of the unbound cells are trapped and destroyed by bound cells because the magnetic force is very strong normally up to 4000 gauss. On the other hand, according to its physical structure, it is more difficult to be processed automatically.

Unfortunately, this technique may result in trapping cells of interest within the mass of magnetic conjugates and thereby losing such cells.

### SUMMARY OF THE INVENTION

A device for concentrating cells of interest from a fluid sample comprises an array of electromagnets associated with an array of holders for containers of the fluid samples, said electromagnets controlled by a microprocessor to generate controllable magnetic fields. Magnetic beads having an affinity for certain of the cells in the fluid sample are added to the fluid sample. When the microprocessor applies electrical current to the electrical magnet(s), the cells linked with magnetic beads will be attracted to the tube wall. Liquid aspirated from the sample will contain comparatively few of the cells for which the magnetic beads have an affinity, thereby allowing concentration of cells of interest. Optionally, aspiration may be accomplished using a robotic pipette system.

The Automated Magnetic Sorter (AMS) contains a Magnetic Sorter, optionally combined with a Robotic System, comprising an array of Electro-magnets with rows of tube racks for holding tubes containing blood samples which have been treated with a compound so as to attach a magnetic probe to components which are not of interest. Once the tubes are in place, a voltage of a DC Power supply, controlled by a microprocessor, is applied to one or more Electro-magnets thereby creating a magnetic field of predetermined strength. In addition, the magnetic field intensity applied to each tube can be adjusted by changing the voltage to the Electro-magnets. Thus, the operator of the AMS can adjust the field to achieve selection of certain components, and can gradually increase the field so as to reduce the trapping effect.

Optionally, a robotic pipette system can cooperate with this ElectroMagnetic Sorter to automate the removal of unbound cells, thereby reducing the required manpower.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is a block diagram of the Automated Magnetic Sorter System hardware.

FIG. 2 is a perspective view of the ElectroMagnetic Sorter (F).

FIG. 3 illustrates the magnetic field generated by applying electrical current to the first and second ElectroMagnets (A).

FIG. 4 is a flow chart of CCCT processes.

FIG. 5 is a flow chart of ElectroMagnetic Sorter (F) processes.

FIG. 6 is a perspective view of a traditional magnetic sorter (Z).

FIG. 7 is a circuit diagram of Microprocessor Interface Board (L).

FIG. 8 is a circuit diagram of ElectroMagnetic Sorter (F).

FIG. 9 is a perspective view of ElectroMagnetic Sorter (F), llustrating transfer of liquid between tubes.

FIG. 10 is a perspective view of an ElectroMagnet (A), illustrating its physical structure.

### DESCRIPTION OF THE PREFERRED EMBODIMENT

The invention will be described by reference to a particular test requiring the separation of cells of interest from a patient's bodily fluid.

The isolation procedure of CCCT applies double gradients (typically with density of 1.068 & 1.083) to a patient's blood sample and uses centrifugation to isolate the red blood cells and plasma. Since the density of cancer cells is in the range of white blood cells that will stay in one gradient (1.083), Magnetic Beads, CD45 that can react with the white blood cells, are added to the tube that contains this gradient. This tube is put into the slot of a magnetic sorter that has a permanent magnet. Due to magnetic field of the magnet, white blood cells linked with the Magnetic Beads will be attracted to the tube wall. Thus, the liquid aspirated from the tube contains the cancer cells and few white cells. As a result, the ratio of cancer cells to white blood cells is significantly increased.

Since the isolation procedures are very complex, the entire operation needs a lot of manpower. A robotic pipette system may be used for the isolation procedures to reduce the labor and cost. Due to physical constraints, using the permanent magnetic sorter to isolate white blood cells is difficult to be automated. Therefore, the AMS eases the automation of cancer cell isolation. In addition, the use of electromagnets under computer control allows fine tuning the process to optimize selection efficiency.

Description of the Overall Device

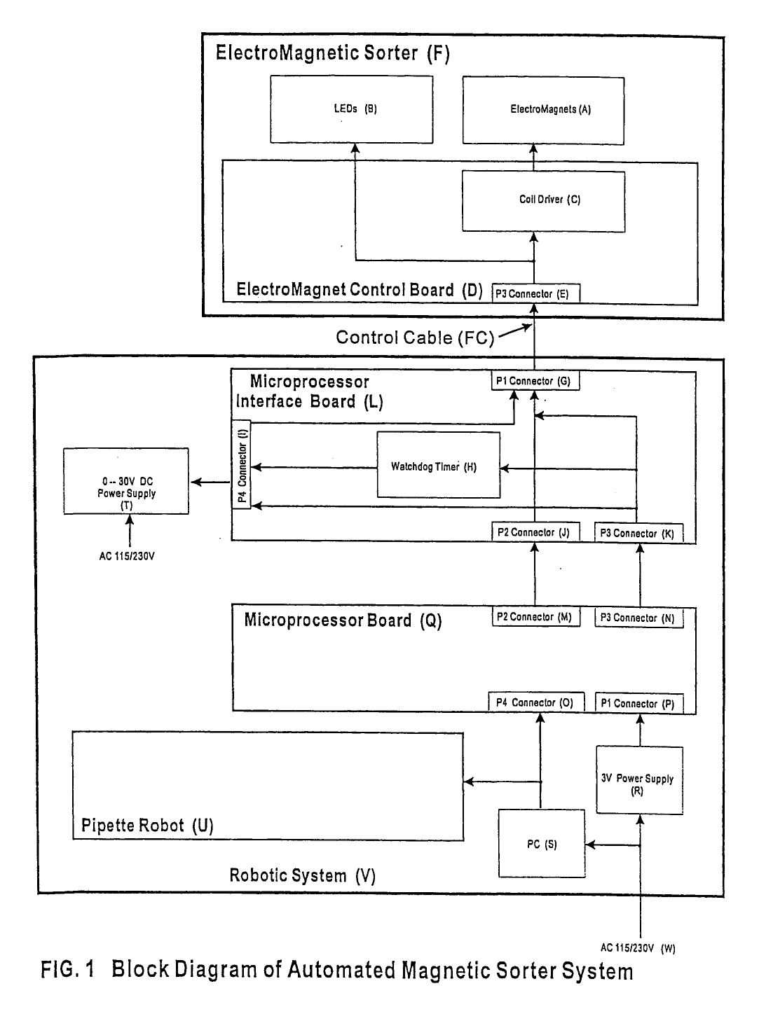

Refer to FIG. 1, Block Diagram of Automated Magnetic Sorter System. The system includes a Robotic System (V) and an ElectroMagnetic Sorter (F). Robotic System has robotic pipette tips that can perform the liquid pipette to/from the test tubes and the reagent containers or waste tanks automatically. It can also control the ElectroMagnetic Sorter (F) to turn ON/OFF the electrical current to ElectroMagnets (A).

ElectroMagnetic Sorter (F) includes the ElectroMagnets (A) and the control circuits. The test tubes can be inserted into the slots of the tube rack adjacent to the ElectroMagnets (A).

Personal Computer (S) in Robotic System can order Microprocessor Board (Q) to turn ON/OFF the electrical current to ElectroMagnets (A) in ElectroMagnetic Sorter (F).

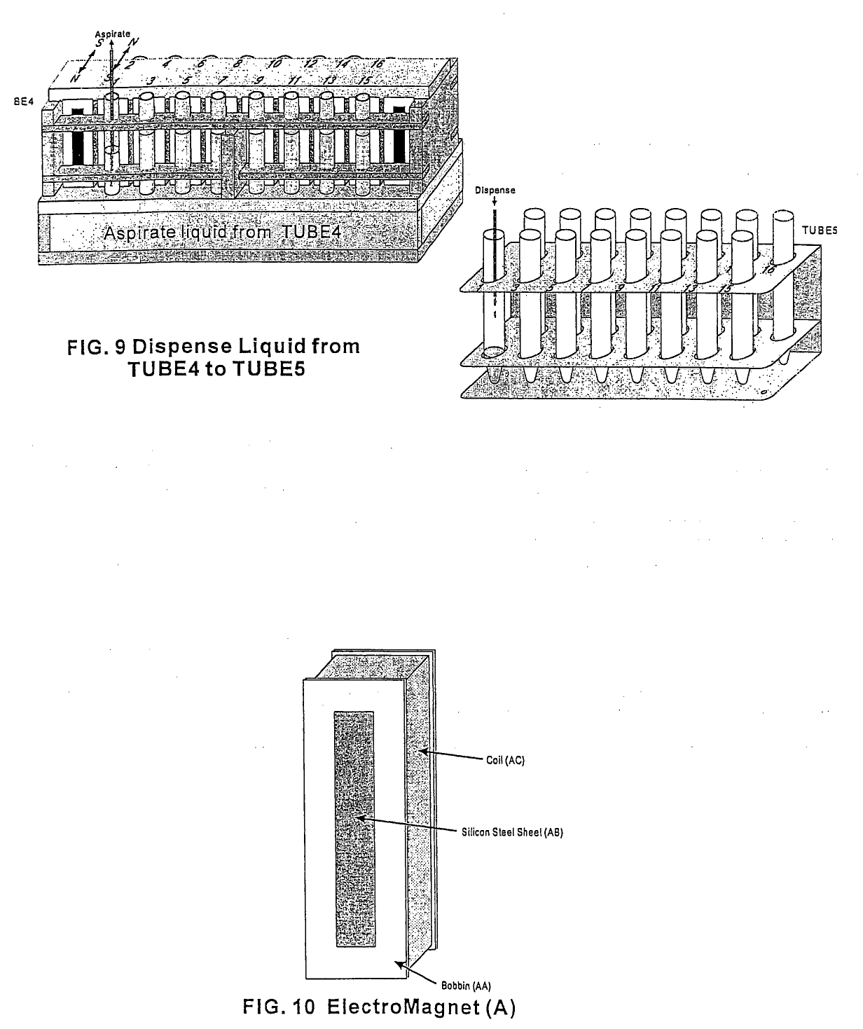

The magnetic beads that anchor with the white blood cells inside the test tubes will be attracted to the tube wall if the ElectroMagnet (A) is energized. Referring to FIG. 9, Robotic System (V) will transfer the liquid that contains the interest cells from the test tubes in ElectroMagnetic Sorter (F) to the other test tubes. In this way, most of the white cells are separated.

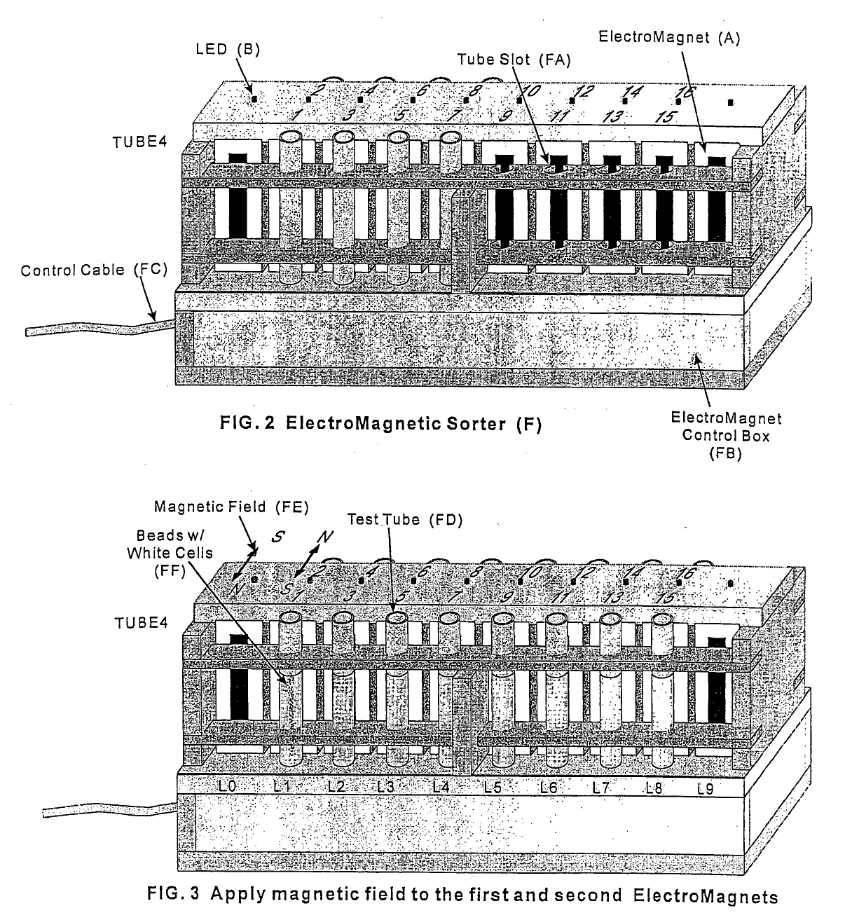

From FIG. 2, ElectroMagnetic Sorter (F) contains an ElectroMagnet Control Board (D) and several ElectroMagnets (A) and LEDs (B). The ElectroMagnet Control Board (D) locates in ElectroMagnet Control Box (FB).

Referring to FIG. 3, ElectroMagnet Control Board (D) receives the signals sending from Robotic System to turn ON/OFF the current to ElectroMagnets (A). The LEDs (B) show the ON/OFF status of each ElectroMagnet (A). Each ElectroMagnet (A) has two tube slots for test tubes. A blood sample to which magnetic beads have been added is put in the test tubes. Most of the white cells anchored to the magnetic beads are attracted to the tube wall when electrical current is applied to the ElectroMagnet (A).

Robotic System (V) uses the pipette tip to aspirate the liquid from ElectroMagnetic Sorter (F) to the other test tubes. In this way, the white cells are isolated.

As shown in FIG. 1, Robotic System (V) contains Pipette Robot (U), Microprocessor Interface Board (L), Microprocessor Board (Q), 0-30V DC Power Supply (T), Personal Computer (S), and 3V Power Supply (R).

The Pipette Robot (U), under the supervision of Personal Computer (S), performs the pipette activities to transfer the liquids among test tubes, waste tanks, reagent containers. The Personal Computer (S) also sends commands to Microprocessor Board (Q), so that the Microprocessor Board (Q) may send the ON/OFF signals through Microprocessor Interface Board (L) to turn ON/OFF the ElectroMagnets (A) in ElectroMagnetic Sorter (F). The Microprocessor Board (Q) also control the output voltage of 0-30V DC Power Supply (T). Different voltages will cause different magnetic field strength to be generated by ElectroMagnets (A). Microprocessor Interface Board (L) contains the Watch Dog Timer (H) that sets the output voltage of 0-30V DC Power Supply (T) to zero if the Microprocessor Board (Q) is out of service due to hardware or software problems to protect the ElectroMagnets (A) from being burnt out. The 3V Power Supply (R) provides the DC power to Microprocessor Board (Q).

Microprocessor Board (Q) receives commands from Personal Computer (S). The output pins of Microprocessor Board (Q) go through P2 (J) and P3 (K) connectors to P1 Connector (G) of Microprocessor Interface Board (L), then go through Control Cable (FC) to Coil Driver (C) in ElectroMagnet Control Board (D) to control the electrical current ON/OFF apply to ElectroMagnets (A). The LEDs (B) show the ON/OFF status of each ElectroMagnet (A). Personal Computer (S) also sends commands to Pipette Robot (U) to do the pipette works. 3V Power Supply (R) provides the power for Microprocessor Board (Q). 0-30V DC Power Supply (T), whose output voltage is controlled by Microprocessor Board (Q) through Microprocessor Interface Board (L), will supply the voltage and current to the Coil Driver (C) to drive the ElectroMagnets (A). The Watchdog Timer (H) will inhibit the voltage output from 0-30V DC Power Supply (T) once the software of Microprocessor Board (Q) is abnormal due to hardware or software problems so that both the ElectroMagnet (A) and Coil Driver (C) will not be burned out.

The Software in Microprocessor Board (Q) calculates the accumulated heat energy for each ElectroMagnet (A). When the heat energy is too much and might damage the ElectroMagnet (A) or Coil Driver (C), the Microprocessor Board (Q) will turn the ElectroMagnet (A) off.

Circuit Descriptions

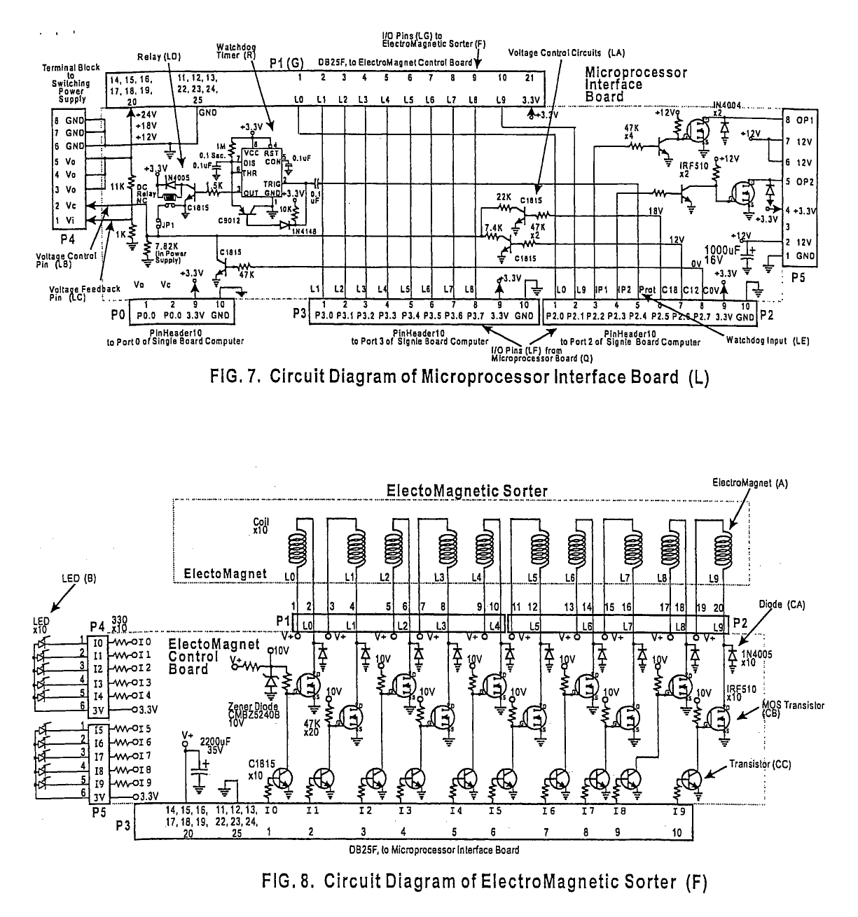

Refer to FIG. 7, Circuit Diagram of Microprocessor Interface Board (L). There are two ports of I/O pins (LF) from Microprocessor Board (Q) connected with P3 (P3.0-P3.7) and P2 (P2.0-P2.7). Ten of these I/O pins (LG) go to P1 (G) directly, and connect to ElectroMagnetic Sorter (F) to control the ON/OFF of ten ElectroMagnets (A). Three of the I/O Pins (LF), P2.5, P2.6 and P2.7 are used to send out the resistance to Voltage Control Pin (LB) so that the output voltage of 0-30 VDC Power Supply (T) can be changed among 0V, 12V, 18V and 24V. One of the I/O pins, P2.4, receives signals from Microprocessor Board (Q) for Watchdog Input (LE) to trigger the Watchdog Timer (R). The Relay (LD) will be always activated if the Watchdog Input (LE) is receiving square wave continuously. The Relay (LD) contact is always open and the 0-30 VDC Power Supply is controlled by Microprocessor Board (Q). Once there is a mistake in the hardware or software in Microprocessor Board (Q) that stops the square wave from Watchdog input (LE), the Relay (LD) will be inactive and its contact closes. Thus, the Voltage Control Pin (LB) is connected to ground and turns the output of 0-30 VDC Power Supply (T) to 0V. Consequently, all the ElectroMagnets are inactive.

Refer to FIG. 8 for the Circuit Diagram of ElectroMagnetic Sorter (F) The I/O pins from Microprocessor Board (Q) through Microprocessor Interface Board are sent to Transistors (CC). When the input to Transistor (CC) is low, the high output will turn ON the MOS Transistor (CB). Then, the current will flow through ElectroMagnet (A). On the other hand, the low input to Transistor (CC) also provides current to the correspondent LED (B) so that the LED will be turned on. The high input to Transistor (CC) will turn off both ElectroMagnets and LEDs.

Description of Operation

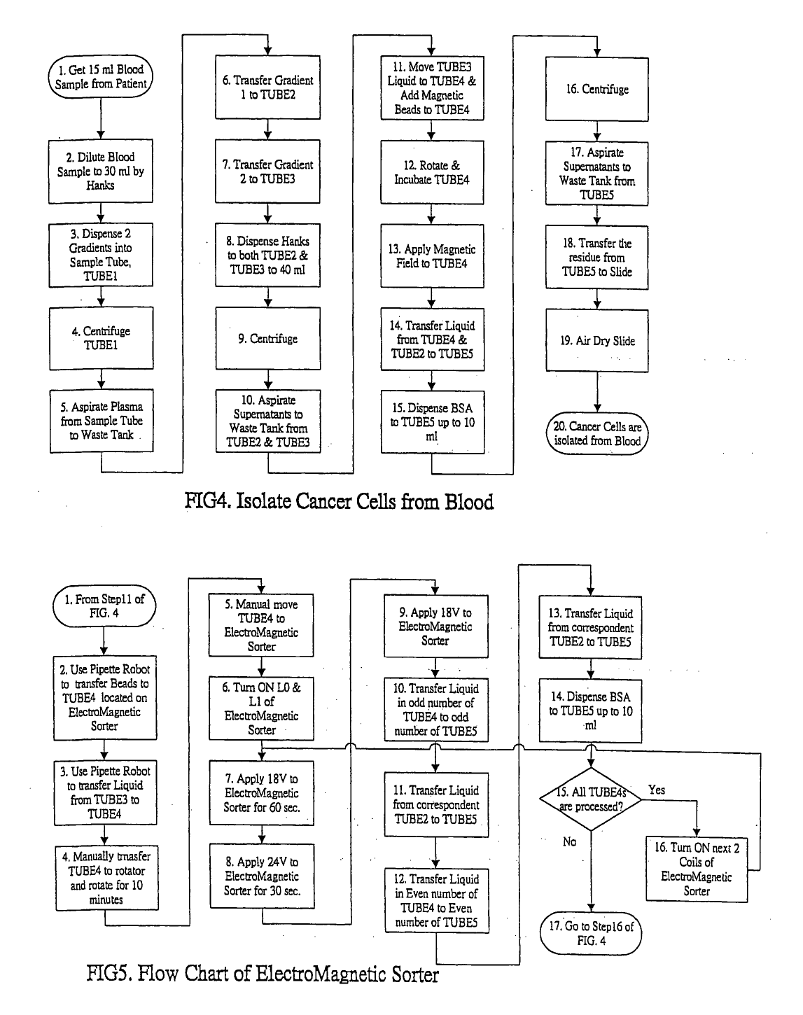

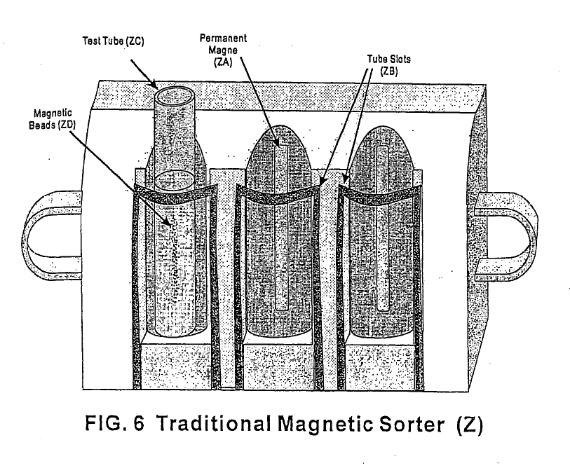

The operation of the system will be illustrated by using the example of isolating Cancer Cells from Blood using the CCCT. A flow chart of the CCCT process is illustrated in FIG. 4. Note that:

From Step 1 to Step 7: the blood samples are isolated into two parts: TUBE2 contains Gradient 1 (1.068) and some lighter cancer cells. TUBE2 contains Gradient 2 (1.083), white cells and some heavier cancer Cells.

From Step 8 to Step 10: Wash out gradients from TUBE2 and TUBE3.

From Step 11 to Step 13: Use Magnetic Beads to get rid of white cells from TUBE3.

From Step 14 to Step 20: Wash again and deposit the cancer cells to slides.

The Automated Magnetic Sorter invention replaces Steps 11 to Step 13 so that the isolation of white cells can be done automatically and more effectively.

The process using Automated Magnetic Sorter to isolate White Cells from Blood is illustrated in flow chart form in FIG. 5.

Step 1: Place Test Tube (FD), TUBE4s, to ElectroMagnetic Sorter (F). Refer to FIG. 3.

Step 2: The Pipette Robot (U) transfers CD45 Beads from reagent container to each TUBE4 in ElectroMagnetic Sorter (F).

Step 3: The Pipette Robot transfers Liquid from each TUBE3 to the correspondent TUBE4.

Step 4: Manual mount all TUBE4s to a rotator to rotate for an effective time, preferably approximately 10 minutes.

Step 5: Manual move TUBE4s back to ElectroMagnetic Sorter (F).

Step 6: PC (S) turns on the first 2 ElectroMagnets, L0 & L1 so that the voltage provided by 0-30 VDC Power Supply (T) can be sent to these 2 ElectroMagnets.

Step 7: PC (S) orders 0-30 VDC Power Supply (T) to provide 18 V for 30 seconds so that the magnetic field (FE) generated for #1 & #2 TUBE4 is about 520 Gauss. Please refer to FIG. 3. The white cells coupled to magnetic Beads (FF) will be attracted to the wall. The reason to turn on the left most ElectroMagnet, L0, is to enhance the magnetic field to the first 2 tubes (#1 & #2) (FD) located by L1 position for about 20% stronger.

Step 8: PC (S) orders 0-30 VDC Power Supply (T) to provide 24 V for 20 seconds so that the magnetic field (FE) generated for #1 & #2 TUBE4 is about 680 Gauss.

Step 9: PC (S) orders 0-30 VDC Power Supply (T) to provide 18 V. so that the magnetic field (FE) generated for #1 & #2 TUBE4 (FD) is about 520 Gauss.

Step 10: Pipette Robot (U) transfers liquid from #1 of TUBE4 (FD) to #1 of TUBE5. Refer to FIG. 9.

Step 11: Pipette Robot (U) transfers liquid from #1 of TUBE2 to #1 of TUBE5.

Step 12: Pipette Robot (U) transfers liquid from #2 of TUBE4 (FD) to #2 of TUBE5.

Step 13: Pipette Robot (U) transfers liquid from #2 of TUBE2 to #2 of TUBE5.

Step 14: Pipette Robot (U) dispenses BSA to #1 of TUBE5 up to 10 ml.

Step 15: PC (S) decides if there is any more TUBE4, it goes to Step 16. Otherwise, it goes to Step 17.

Step 16: PC (S) turns on the next two ElectroMagnets, L1 & L2. Therefore, the voltage provided by 0-30 VDC Power Supply (T) later can be sent to these 2 ElectroMagnets for #3 & #4 TUBE4 (FD). Then it goes to Step 7.

Step 17: If all TUBE4s (FD) are processed, goes to Step 16 of FIG. 4.

Note that one of the advantages of the Automated Magnetic Sorter over the prior art is that the strength and timing of the magnetic field may be controlled. Thus, for example, in step 7 if it is determined that 520 Gauss is an ineffective field strength, the software controlling the PC may be modified to select an effective strength (or to automatically test a series of strengths to determine the most effective).

While illustrated with respect to the CCCT test (Cell Works Inc.), the invention may be applied to any test requiring the separation of specified cells or types of cells from a fluid sample, using the same techniques, modified in a manner which would be known to one skilled in the art.

Therefore, while a specific embodiment of the invention has been shown and described in detail to illustrate the application of the principles of the invention, it will be understood that the invention may be embodied otherwise without departing from such principles and that various modifications, alternate constructions, and equivalents will occur to those skilled in the art given the benefit of this disclosure.

What is claimed is:

1. An Automated Magnetic Sorter for separating predefined components from a bodily fluid sample, comprising a receptacle for bodily fluid sample vials and, adjacent thereto, a microprocessor controlled electromagnet for creating a magnetic field, said microprocessor programmed to allow a user to select the strength of said magnetic field as a function of time so as to control the flow of magnetic components of said bodily fluid sample.

2. An Automated Magnetic Sorter as in claim 1, wherein said bodily fluid is blood.

3. An Automated Magnetic Sorter as in claim 1, further comprising a robotic pipette system for removing from said bodily fluid sample vials components of said bodily fluid sample which are not magnetically charged.
